(19) United States
(12) Patent Application Publication
(10) Pub. No.: US 2008/0149594 A1
(43) Pub. Date: Jun. 26, 2008

(54) APPARATUS AND PROCESS FOR FORMING AND HANDLING POROUS MATERIALS

(75) Inventors: David W. Yen, Dayton, OH (US); JingYing Zhang, Kirkland, WA (US); John C. Christenson, Kokomo, IN (US); Peter J. Schubert, Naperville, IL (US)

Correspondence Address: HARTMAN & HARTMAN, P.C., 552 EAST 700 NORTH, VALPARAISO, IN, 46383, US

(73) Assignee: PACKER ENGINEERING, INC., Naperville, IN (US)

(21) Appl. No.: 11/764,327

(22) Filed: Jun. 18, 2007

Related U.S. Application Data
(60) Provisional application No. 60/814,676, filed on Jun. 16, 2006.

(51) Int. Cl. B31D 3/00; C23F 4/00

(52) U.S. Cl. 216/56; 156/345.23; 156/345.51

(57) ABSTRACT

An apparatus and process for producing a porous particulate media, such as nano-porous silicon (npSi). The apparatus has a rigid etching chamber configured to contain an etching reagent, an inlet for introducing the etching reagent into the etching chamber, and an outlet for outflow of the etching reagent from the etching chamber. One or more porous filter bags contain powders of a starting material for the porous particulate media, and are secured apart from each other within the etching chamber to enable contact between the etching reagent and the powders within the filter bags. Each filter bag is characterized by a pore size sufficiently small to confine the powders within the filter bag but sufficiently large to enable the etching reagent to flow through the filter bag. The etching reagent is flowed through the filter bags to etch the powders within each bag and produce the porous particulate media.

### CROSS REFERENCE TO RELATED APPLICATIONS

This application claims the benefit of U.S. Provisional Application No. 60/814,676, filed Jun. 16, 2006, the contents of which are incorporated herein by reference.

### STATEMENT REGARDING FEDERALLY SPONSORED RESEARCH

This invention was made with United States Government support from Edison Materials and Technology Center (EMTEC), Contract No. EFC-H2-3-1C. The Government has certain rights in this invention.

### BACKGROUND OF THE INVENTION

The present invention relates to processes and apparatuses used in the treatment of materials. More particularly, this invention relates to processes and apparatuses for producing porous media, such as nano-porous silicon (npSi) suitable for use in the storage and retrieval of elemental hydrogen.

Hydrogen-based fuel cell technologies are being considered for a wide variety of power applications, including but not limited to mobile applications such as vehicles as an attractive alternative to the use of petroleum-based products. Hydrogen-based fuel cells are also readily adaptable for use as energy sources in numerous and such diverse applications as cellular phones to space ships. They have the further desirable attribute of producing water vapor as their only byproduct and are thus environmentally benign.

Efficient storage of hydrogen is vitally important for cost-effective system implementation. When compared to storage for conventional chemical fuels or electric energy sources, existing hydrogen storage technologies lack the convenience of gasoline for delivery and storage capacity (energy density per unit weight), and lack the flexibility of electrical energy stored in batteries and capacitors. Therefore, for fuel cells to reach their full commercial potential, improved hydrogen storage technologies are needed.

Prior methods of storing hydrogen fall broadly into two categories. The first category involves storing hydrogen chemically within a convenient chemical molecule, usually an aliphatic organic compound such as methane, octane, etc., and then pre-processing the fuel as needed, such as by catalytic reforming, to release elemental hydrogen plus carbon oxides. This method suffers two important drawbacks: carbon dioxide byproduct is a “greenhouse gas” that some believe contributes to global warming and is therefore environmentally undesirable; and the additional weight of the chemical molecule and the reformer reduce the efficiency of the entire process, making it less attractive from a cost and performance standpoint.

The second category involves mechanical or adsorptive storage of elemental hydrogen in one of three forms: compressed gas, cryogenically-refrigerated liquid, or chemisorbed onto active surfaces. Of these methods, compressed gas storage is the most straightforward and is a mature technology. However, compressed gas cylinders are quite heavy, needing sufficient strength to withstand pressures of many thousands of pounds per square inch. This weight is a considerable drawback for portable applications, and in any usage compressed gas cylinders must be treated with care because they represent a safety hazard.

Cryogenic storage of hydrogen is also well known, being used in industrial plants and as a rocket fuel. Liquid hydrogen is remarkably dense from a specific energy point of view (kilowatts per kilogram), but requires a considerable amount of additional energy to maintain the nearly absolute zero temperatures needed to keep hydrogen in a liquid state. Liquid hydrogen also requires a heavy mass of insulation, and these factors conspire to make cryogenic storage impractical for portable and small-scale applications.

Chemisorption as used herein means the adsorption of a given molecule onto an active surface, typically of a solid or a solid matrix. Chemisorption is typically reversible, although the energy of adsorption and the energy of desorption are usually different. Various catalysts and surface preparations are possible, providing a wide range of possible chemistries and surface properties for a given storage problem. Chemisorption of hydrogen has been studied extensively, and substances such as metal hydrides, palladium, and carbon nanotubes or activated carbon have been used to adsorb and desorb hydrogen.

Prior hydrogen chemisorption techniques have fallen short of the goals of efficiency, convenience, and low system cost for several reasons. In some materials, such as carbon nanotubes, the efficiency of hydrogen adsorbed per unit weight of matrix is moderate, but the method of desorption requires high heat, which brings about danger of combustion. Additionally, the present cost of carbon nanostructures is relatively high, and control over material properties can be quite difficult in high-volume manufacturing. In the case of metal hydrides, metal oxides, and other inorganic surfaces, storage efficiencies typically are lower and the adsorption/desorption process is highly dependent upon exacting chemistry. These factors combine to make such approaches less than sufficiently robust for many commercial applications.

Hydrogenated surfaces in silicon have also been employed, as disclosed in U.S. Pat. Nos. 5,604,162, 5,605,171, and 5,765,680, the disclosures of which are incorporated herein by reference. In each of these references, the adsorbed molecule is the radioactive hydrogen isotope tritium (³H), and the objective is the storage of this isotope to enable its safe transport, typically to a waste handling or storage facility, or to serve as a means for providing radioactive energy to power a light source. These prior methods of chemisorption do not, however, provide for desorption of hydrogen from a silicon storage medium. In fact, conventional methods of chemisorption are generally designed to prevent desorption. Further, these conventional methods of chemisorption fail to teach methods by which the storage capacity of a silicon matrix can be increased.

As a solution to the forgoing, a system for storage and retrieval of elemental hydrogen on nano-porous silicon (npSi) media is described in U.S. Published Patent Application No. 2004/0241507 to Schubert et al., the disclosure of which is incorporated herein by reference.

Methods of forming silicon into a crystalline matrix having semiconductive properties and selectively forming regions of npSi in such crystalline matrices are well known. For example, applying a mixture of even parts of hydrofluoric acid and methanol to a crystalline silicon matrix at a current density of about 50 mA/cm² renders single-crystal silicon porous, as is more fully described in Timoshenko et al., “Infrared Free Carrier Absorption in Mesoporous Silicon,” Rapid Research Notes, Phys.Stat.Sol. (b) 222, R1 (2000), the disclosure of which is incorporated herein by reference. Yet another method of selectively forming regions of npSi in a semiconductive crystalline matrix is taught in U.S. Pat. No. 6,407,441, the disclosure of which is incorporated herein by reference.

Porous silicon provides a favorable balance between having a high surface area and maintaining an open matrix that allows hydrogen gas to diffuse into and out of the matrix. The npSi layer formed by methods such as those described above exposes one or more of the four valence bonds on the outer orbital of the silicon atoms within the crystalline structure. These exposed valence bonds are highly active and will readily accept and store hydrogen atoms. Additional unique characteristics of npSi, such as controllable adsorption surface energy and transparency to IR radiation at certain frequencies, enhance its promise as hydrogen storage media.

Because the exposed valence bonds of npSi will also readily bond to other atoms such as, for example, oxygen, the etched npSi must be isolated from reactive elements and compounds. Thus, during and after processing, etched npSi must be contained or enclosed within controlled environments that prevent exposure of the silicon to substances other than those required to process the silicon and use the resulting npSi, for example, the etchants used to form the porosity, suitable rinsing solutions to remove the etchants, hydrogen (or other substance to be stored), and inert gases, for example, argon and helium.

Porous silicon is usually formed by electrochemical etching, with its main application due to its photoluminescence characteristic. In order to obtain free npSi, the npSi layer formed on a substrate should be removed intact from the substrate. Typically, only a thin layer of npSi can be formed on a substrate, because the outermost portion of the npSi layer may etch away as npSi forms at the reaction front beneath the outermost portion. As a result, electrochemical etching techniques on bulk substrates are not well suited for producing npSi on a large scale.

To maximize the surface area of npSi and scale up its mass production, it would be desirable to use silicon particles or powders rather than silicon wafers as npSi precursors to form porous silicon. Since it would be impractical to electrochemically etch individual particles of a silicon powder, a purely chemical method of making npSi, referred to as a “stain etch,” has typically been used. Conventional stain etch processes are carried out generally as follows: a silicon powder is immersed in a stain etch solution, which is usually a mixture of HF, HNO₃, and H₂O in volume ratios of, for example, about 1:1:20, 2:1:20, 3:1:20, 4:1:20, and 5:1:20. Continuous stirring is applied to accelerate the etching process, which may be performed for extended periods, for example, up to 2.5 hours. The etched powders, which are generally collected by centrifuge or settling from the etching solution, need to be rinsed first with ethanol, collected again by centrifuge, rinsed by pentane, and collected once again by centrifuge before being dried under vacuum.

Such standard stain etch methods are typically used for small batch preparation and are not suitable for large scale, lowcost production. Particle sizes of silicon powders are often in the range of about 5 to about 25 micrometers, and therefore can be easily inhaled or ingested if handled directly by persons, thereby posing a potential health hazard. Furthermore, as discussed above, the multiple steps required to prepare npSi from silicon powders make it a somewhat inefficient process. The health hazards and inefficiencies continue during transport of the etched silicon powders from their production to their application site.

### BRIEF SUMMARY OF THE INVENTION

The present invention provides apparatuses and processes suitable for producing porous particulate media, such as nano-porous silicon (npSi) powders, and capable of large scale, lowcost production of such media with reduced health hazards before, during, and after processing.

According to a first aspect of the invention, an apparatus for producing porous particulate media includes a rigid etching chamber configured to contain an etching reagent, an inlet for introducing the etching reagent into the etching chamber, and an outlet for outflow of the etching reagent from the etching chamber. One or more porous filter bags contain powders of a starting material for the porous particulate media. Each filter bag is characterized by a pore size sufficiently small to confine the powders within the filter bag but sufficiently large to enable the etching reagent to flow through the filter bag. The filter bags are secured apart from each other within the etching chamber to enable contact between the etching reagent and the powders within the filter bags.

According to a second aspect of the invention, a process for producing porous particulate media includes securing one or more porous filter bags within a rigid etching chamber configured to contain an etching reagent. Each filter bag contains powders of a starting material for the porous particulate media, is characterized by a pore size sufficiently small to confine the powders within the filter bag but sufficiently large to enable the etching reagent to flow through the filter bag, and is secured so as to be spaced apart from other filter bags within the etching chamber to enable contact between the etching reagent within the etching chamber and the powders within the filter bags. The etching reagent is then introduced into the etching chamber, and flows through the filter bags to etch the powders within each of the filter bags and produce the porous particulate media. The etching reagent is then removed from the etching chamber.

In view of the above, it can be seen that a significant advantage of this invention is that the filter bags facilitate handling of powders during etching, and are also beneficial for containing the etched powders (porous particulate media) during rinsing as well as during subsequent process steps including drying, storing, and transporting the particulate media. As such, the filter bags are able to confine the particulate media in a manner that mitigates handling difficulties and health hazards. Depending on the size of the etching chamber and the number of filter bags used, large-scale, lowcost production of etched particulate media can be readily achieved.

Other objects and advantages of this invention will be better appreciated from the following detailed description.

### BRIEF DESCRIPTION OF THE DRAWINGS

FIG. 1 schematically represents a first embodiment of an etching apparatus in accordance with the present invention.

FIG. 2 is a cross-sectional view of the apparatus of FIG. 1.

FIGS. 3 and 4 schematically represent two additional embodiments of etching apparatuses in accordance with the present invention.

FIG. 5 schematically represents an alternative configuration for the etching apparatus of FIG. 4.

### DETAILED DESCRIPTION OF THE INVENTION

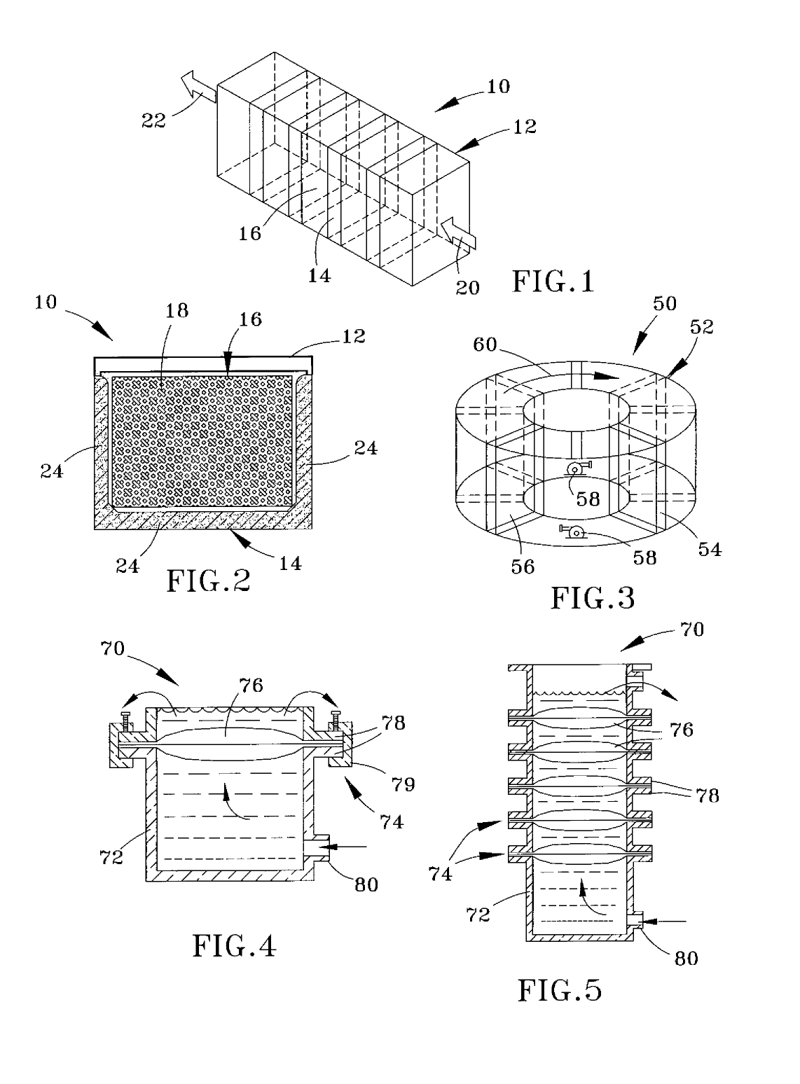

FIGS. 1 through 5 schematically depict equipment suitable for economical large-scale production of nano-porous silicon (npSi) by chemical etching processes in amounts that can be safely handled and transported. In FIG. 1, an etching apparatus 10 shown as including a rigid rectangular etching chamber 12 equipped with fixtures 14 for securing porous filter bags 16 that serve as containers for powders 18 (FIG. 2) undergoing etching. The etching chamber 12 further includes an inlet 20 for introducing an etching reagent into the chamber 12 and an outlet 22 for outflow of the etching reagent from the chamber 12. Suitable etching reagents will depend on the particular powder material being etched. Of particular interest to the present invention is silicon for the production of npSi powders, though it should be understood that the apparatus 10 could be employed to etch powders of various other materials, including other potential hydrogen storage materials such as germanium. For producing npSi, suitable etching reagents include aqueous etching solutions typically used in stain etching processes, such as mixtures of HF, HNO₃, and H₂O in volume ratios of, for example, about 1:1:20, 2:1:20, 3:1:20, 4:1:20, and 5:1:20. Because water and aqueous acid solutions are known to have significant surface tensions whose forces can collapse fragile porous silicon structures, a low surface tension rinse, such as with ethanol and pentane used in conventional stain etch practices, is preferably performed after etching. The apparatus 10 can be configured so that both etching of the silicon powders 18 and rinsing of the resulting npSi powders can be performed in the chamber 12.

Each porous filter bag 16 can define a single compartment or be separated into multiple compartments to promote a more even distribution of the silicon powder 18 within each bag 16. The filter bags 16 can have a mesh, woven, perforated, or similar construction to define pores with sizes small enough to effectively confine the silicon powder 18 within the bags 16 but large enough to enable the etching and rinsing solutions to freely flow in and out of the bags 16. The maximum pore size for the bags 16 is preferably smaller than the smallest powder particles to be retained in the bags 16. As an example, for a silicon powder 18 having a minimum particle size of about 5 micrometers, a preferred maximum pore size is about 4.0 micrometers, with a suitable range being about 0.5 to about 2.5 micrometers, and for a silicon powder 18 having a minimum particle size of about 25 micrometers, a preferred maximum pore size is about 20 micrometers, with a suitable range being about 0.5 to about 15 micrometers.

The filter bags 16 should also be constructed in such a way as to minimize stretch, thereby preventing sagging of the bags 16 and the escape of silicon particles therefrom. Suitable materials from which the filter bags 16 may be constructed must also be non-reactive toward the silicon powder material, etching solutions, and rinsing solutions used to remove etching solutions from the npSi produced by the etching process. In addition, suitable materials for the filter bags 16 should possess good hydrophilic properties to reduce capillary forces and facilitate the release of any bubbles generated during the etching process. In view of the foregoing, a suitable hydrophilic material for the construction of bags 16 is believed to be a Teflon microfiber material. Other potential materials that exhibit less than optimal hydrophilic properties, for example, polypropylene microfiber materials, may be coated or treated to improve their wettability. Another option is to form the bags 16 to have portions that are hydrophillic and other portions that are hydrophobic. As noted above, hydrophillic properties facilitate wetting for liquid etching. On the other hand, hydrophobic characteristics are able to promote egress for gaseous hydrogen evolved during the etch process. As such, the apparatus 10 can make use of bags 16 having entirely hydrophillic surfaces and bags 16 having some surface regions that are hydrophillic and others that are hydrophobic.

The filter bags 16 can be sealed using, for example, heat-seal techniques around their entire perimeters. If the filter bags 16 are desired to be reusable, one or more of their edges can be configured to be resealable using, for example, a stainless steel ring, an acid-resistant polymer, a zip closure, or other nonpermanent sealing feature. As shown in FIG. 2, the bags 16 may be secured along three sides of their perimeters using the fixtures 14 located along three of four sides of the etching chamber 12 to ensure that the etching solutions must flow through the filter bags 16 and fully contact the silicon powders 18 within the bags 16. For this purpose, FIG. 2 represents one of the fixtures 14 as including flanges 24 capable of clamping each of three sides of a filter bag 16. The flanges 24 may be covered by an elastic or deformable material to reduce stress concentrations. The etching chamber 12 may be configured to permit access to and opening of the unclamped upper edge of each bag 16 while the bags 16 remain within the chamber 12. Such a capability permits an etching solution to be poured directly into the interior of a bag 16.

The etching and rinsing solutions can be circulated through the chamber 12 at speeds sufficient to fully mix with the silicon powder 18 in each bag 16, thereby accelerating the etching process. Optimum packing densities of the silicon powder 18 in each filter bag 16 and the flow velocity of the etching and rinsing solutions can be experimentally determined to optimize the etching process.

Gases such as hydrogen are typically generated during etching processes to produce porous silicon, and must be accommodated or released from the filter bags 16 and the etching chamber 12 during the etching process. A moderate vacuum applied to the uppermost edge or surface of each filter bag 16 could be successfully employed to draw off evolved hydrogen bubbles, thus preventing over-pressurizing or rupturing of the bags 16 during processing of the npSi and during the recovery of stored hydrogen. A standpipe arrangement can be used to ensure that the powder particles fall back into the bags 16 under the force of gravity, thereby ensuring that only hydrogen is removed by the vacuum.

FIG. 3 schematically depicts an etching apparatus 50 with a cylindrical etching chamber 52 according to a second embodiment of the invention. The cylindrical shape of the chamber 52 is intended to allow for the recirculation of etching and rinsing solutions through a plurality of filter bags 56 secured within the chamber 52 with radially-oriented fixtures 54. The fixtures 54 and the bags 56 they secure are preferably similar in function and construction to the fixtures 14 and bags 16 of the first embodiment and represented in FIG. 2. The fixtures 54 and filter bags 56 can be held stationary within the cylindrical chamber 52, with the etching and rinsing solutions pumped through the chamber 52 in a circular path as indicated by the arrow 60. Recirculation of the etching and rinsing solutions through the chamber 52 can be enhanced by the use of one or more recirculating pumps 58. Alternatively or in addition, the fixtures 54 can be rotated within the cylindrical chamber 52 to force the bags 56 through the etching and rinsing solutions.

FIG. 4 schematically depicts a third embodiment of an etching apparatus 70 of this invention. In contrast to the vertically-oriented filter bags 16 and 56 of the previous embodiments, the porous filter bag 76 of FIG. 4 is shown as being horizontally oriented within a vertical etching chamber 72 through which etching and rinsing solutions flow vertically. The etching and rinsing solutions are indicated as being introduced through an inlet port 80 at the lower end of the chamber 72, flowing upwardly through the filter bag 76, and then overflowing the upper end of the chamber 72 before returning to reservoirs (not shown) by gravity. The filter bag 76 is shown clamped between a pair of flanges 78 that, in combination with one or more clamps 79, make up a fixture 74. The vertical flow of the etching and rinsing solutions reduces the risk of damage to the bag 76 by minimizing pressure gradients across the surface of the bag 76, and the upward flow balances the downward gravity effect of the powder within the bag 76, thereby reducing splashing during introduction of the etching solution. FIG. 5 represents how a stack of fixtures 74 and bags 76 can be installed on the apparatus 70 of FIG. 4 to enable silicon powders placed in multiple bags 76 to be simultaneously etched.

Regardless of the configuration of the etching apparatus 10, 50, or 70, it is important that the etching solution passes through all the filter bags 16, 56, and 76 at a concentration and flow rate such that the silicon powders within the bags 16, 56, and 76 are uniformly etched. Etching conditions, including the acids used, acid concentrations, surfactants and other additives, temperature, pressure, catalysts, etc., can be optimized to produce a desired nano-porous microstructure in the silicon powder.

The filter bags 16, 56, and 76 containing the silicon powders are beneficial for facilitating the handling of the powders during etching and rinsing without the need for centrifugal collections, and can be further used during the drying, storage, and transport of the npSi produced by the etching process. For example, the bags 16, 56, and 76 filled with the npSi produced during the etching process can be stored in a storage tank (not shown) having fixtures similar to the fixtures 14, 54 and 74 used to secure the bags 16, 56 and 76 within the etching apparatuses 10, 50 and 70. In that storage requires the npSi to be isolated from oxygen and other elements and compounds that might readily bond with the exposed valence bonds of the npSi particles, suitable storage tanks can be filled with an inert gas such as argon and helium. By continuously keeping the bags 16, 56, and 76 closed during and after etching, the conventional requirement for equipping a hydrogen storage tank with a filtration system may be avoided. In contrast to metal hydride systems, compartmentalization of the npSi in the bags 16, 56, and 76 within a storage tank also has the benefit of preventing the settling of the npSi. As such, the filter bags 16, 56, and 76 preferably confine the npSi in a manner that mitigates handling difficulties and health hazards, and prevents the npSi particles from clogging filters or flow lines of the storage tank. Furthermore, the bags 16, 56, and 76 allow modularity for replacement of some portion of the npSi within the storage tank, should some of it become unusable because of poisoning, collapse, or other unforeseen events.

npSi powders prepared by etching with liquid etchants must typically be dried for storage. To avoid the need to rinse and dry the npSi, the apparatuses 10, 50, and 70 can be adapted to utilize vapor phase etching. Examples of suitable vapor phase etching reagents include HF. Elevated pressures (i.e., above atmospheric pressure) within the chambers 12, 52, and 72 can be employed to promote the flow of vapor phase etching reagents through the filter bags 16, 56, and 76 if tightly packed with silicon powders. Intentional loose packing of the silicon particles within the bags 16, 56, and 76 enables fluidization of the particles within the bags 16, 56, and 76 as the vapor phase reagents flow through the bags 16, 56, and 76 during the etch process, facilitating the passage of the vapor phase reagents through the particles at lower pressures and promoting contact of the etching reagents with all surfaces of the particles in the bags 16, 56, and 76. Another option is a subatmospheric vapor phase etch employing a gentle vacuum pulled on the chamber 12, 52, or 72 so that the vapor pressure above a liquid source for the vapor etchant encourages a suitable vapor flux around the particles within the bags 16, 56, and 76.

Finally, the practice of the present invention is compatible with processes by which porous materials such as npSi are produced by applying a magnetic field to a substrate that contains charge carriers, and etching the substrate while relative movement occurs between the substrate and the magnetic field, as disclosed in U.S. Patent Application Serial No. {Attorney Docket No. A7-2276}, which claims the benefit of U.S. Provisional Application No. 60/814,307, the contents of both are incorporated herein by reference.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An apparatus for producing a porous particulate media, the apparatus comprising:
a rigid etching chamber configured to contain an etching reagent;
an inlet for introducing the etching reagent into the etching chamber;
an outlet for outflow of the etching reagent from the etching chamber;
one or more porous filter bags for containing powders of a starting material for the porous particulate media, each of the filter bags being characterized by a pore size sufficiently small to confine the powders within the filter bag but sufficiently large to enable the etching reagent to flow through the filter bag; and
means for securing the filter bags apart from each other within the etching chamber to enable contact between the etching reagent and the powders within the filter bags.

2. The apparatus according to claim 1, wherein the etching chamber has an oblong shape and flow of the etching reagent through the etching chamber is from one end to an oppositely-disposed end of the etching chamber.

3. The apparatus according to claim 2, wherein the flow of the etching reagent through the etching chamber is substantially horizontal.

4. The apparatus according to claim 3, wherein the securing means suspends the filter bags to have a vertical orientation within the etching chamber.

5. The apparatus according to claim 2, wherein the flow of the etching reagent through the etching chamber is substantially vertical.

6. The apparatus according to claim 5, wherein the securing means suspends the filter bags to have a horizontal orientation within the etching chamber.

7. The apparatus according to claim 1, wherein the etching chamber has a cylindrical shape and the securing means suspends the filter bags to have a radial orientation within the etching chamber relative to an axis of the cylindrical shape.

8. The apparatus according to claim 7, wherein flow of the etching reagent is circular through the etching chamber about the axis of the cylindrical shape.

9. The apparatus according to claim 7 wherein the securing means is rotatable within the etching chamber about the axis of the cylindrical shape.

10. The apparatus according to claim 1, wherein the securing means is moveable within the etching chamber.

11. The apparatus according to claim 1, wherein the etching chamber comprises a pump for recirculating the etching reagent through the etching chamber.

12. The apparatus according to claim 1, wherein the etching chamber is configured to contain the etching reagent in liquid phase.

13. The apparatus according to claim 1, wherein the etching chamber is configured to contain the etching reagent in vapor phase.

14. The apparatus according to claim 13, wherein the etching chamber is configured to circulate the etching reagent through the filter bags so as to fluidize the powders within the filter bags.

15. The apparatus according to claim 1, wherein the etching reagent comprises a mixture of HF, HNO₃, and H₂O.

16. The apparatus according to claim 1, wherein the filter bags have entirely hydrophillic surfaces.

17. The apparatus according to claim 1, wherein the filter bags have surface regions that are hydrophillic and others that are hydrophobic.

18. A process for producing a porous particulate media, the process comprising:
securing one or more porous filter bags within a rigid etching chamber configured to contain an etching reagent, the filter bags containing powders of a starting material for the porous particulate media, the filter bags being secured so as to be spaced apart from each other within the etching chamber to enable contact between the etching reagent within the etching chamber and the powders within the filter bags, each of the filter bags being characterized by a pore size sufficiently small to confine the powders within the filter bag but sufficiently large to enable the etching reagent to flow through the filter bag;
introducing the etching reagent into the etching chamber;
flowing the etching reagent through the filter bags to etch the powders within each of the filter bags and produce the porous particulate media; and
removing the etching reagent from the etching chamber.

19. The process according to claim 18, further comprising rinsing and drying the porous particulate media within each of the filter bags following removal of the etching reagent from the etching chamber.

20. The process according to claim 18, wherein the etching chamber has an oblong shape and the etching reagent flows through the etching chamber from one end to an oppositely-disposed end of the etching chamber.

21. The process according to claim 20, wherein the etching reagent flows substantially horizontally through the etching chamber.

22. The process according to claim 21, wherein the filter bags are secured to have a vertical orientation within the etching chamber.

23. The process according to claim 20, wherein the etching reagent flows substantially vertically through the etching chamber.

24. The process according to claim 23, wherein the filter bags are secured to have a horizontal orientation within the etching chamber.

25. The process according to claim 18, wherein the etching chamber has a cylindrical shape and the filter bags are secured to have a radial orientation within the etching chamber relative to an axis of the cylindrical shape.

26. The process according to claim 25, wherein flow of the etching reagent is circular through the etching chamber about the axis of the cylindrical shape.

27. The process according to claim 25 wherein the filter bags rotate within the etching chamber about the axis of the cylindrical shape.

28. The process according to claim 18, wherein the filter bags move within the etching chamber.

29. The process according to claim 18, further comprising recirculating the etching reagent through the etching chamber.

30. The process according to claim 18, wherein the etching reagent is in liquid phase within the etching chamber.

31. The process according to claim 18, wherein the etching reagent is in vapor phase within the etching chamber.

32. The process according to claim 31, wherein the etching reagent flows through the filter bags so as to fluidize the powders within the filter bags.

33. The process according to claim 18, further comprising applying a vacuum to the filter bags during or subsequent to etching.

34. The process according to claim 18, wherein the etching reagent comprises a mixture of HF, HNO₃, and H₂O.

35. The process according to claim 18, wherein the starting material is silicon and the porous particulate media is nano-porous silicon.

36. The process according to claim 18, further comprising the steps of removing the porous particulate media from the filter bags and then refilling the filter bags with additional powders of the starting material for the porous particulate media.

37. The process according to claim 18, wherein the filter bags have entirely hydrophillic surfaces.

38. The process according to claim 18, wherein the filter bags have surface regions that are hydrophillic and others that are hydrophobic.
